(19) United States
(12) Patent Application Publication
(10) Pub. No.: US 2026/0186493 A1
(43) Pub. Date: Jul. 2, 2026

(54) DEVICE AND METHOD FOR PERFORMING LOCALIZATION OF A ROBOT DEVICE

(71) Applicant: dConstruct Technologies Pte. Ltd., Singapore (SG)

(72) Inventors: Zhikai LI, Singapore (SG); Jia Yi CHONG, Singapore (SG); Wenchao GAO, Singapore (SG); Krittin KAWKEEREE, Singapore (SG); Joel Wei Pin LEOW, Singapore (SG)

(21) Appl. No.: 19/131,952

(22) PCT Filed: Nov. 23, 2022
(86) PCT No.: PCT/SG2022/050854

§ 371 Date: May 22, 2025

(51) Int. Cl. G05D 1/246; G05D 109/12; G06T 7/73

(52) U.S. Cl. CPC G05D 1/2465; G06T 7/74; G05D 2109/12; G06T 2207/10028

(57) ABSTRACT

Aspects concern a method for performing localization of a robot device comprising sub-dividing an environment of the robot device into a plurality of voxels and assigning a hash value to each voxel, assigning, to each hash value, a list of map points of a map of the environment of the robot device which are located in the voxel to which the hash value is assigned. The method further comprises, at every iteration of multiple iterations of localization acquiring an observation via a point cloud indicating object surface points in the environment relative to the robot device and evaluating the candidate position using a hash value of the point and the list of map points assigned to the hash value of the point.

### TECHNICAL FIELD

Various aspects of this disclosure relate to devices and methods for performing localization of a robot device.

### BACKGROUND

For an autonomous moving robot device it is necessary that the robot device is capable of determining its location within an environment. This may be done based on map data about the environment and data from a sensor by matching points corresponding to obstacles indicated by the map data with points corresponding to obstacles detected by the sensor (i.e. indicated in the sensor data). Such a localization approach, like for example Monte-Carlo Localization, requires searching for nearest neighbours of points from the sensor data among the points indicated by the map data. Since map data may include a high number of points, approaches are desirable that allow finding nearest neighbours and thus perform localization in a time that makes the localization applicable for real-time control of robot devices.

### SUMMARY

Various embodiments concern a method for performing localization of a robot device including sub-dividing an environment of the robot device into a plurality of voxels and assigning a hash value to each voxel, assigning, to each hash value, a list of map points of a map of the environment of the robot device which are located in the voxel to which the hash value is assigned. The method further includes, at every iteration of multiple iterations of localization
Acquiring an observation via a point cloud indicating object surface points in the environment relative to the robot device; and
Determining, for each of a plurality of candidate configurations of the robot device within the environment, for each point of the point cloud, the hash of voxel to which the point would belong if the robot device were at the candidate position, linearly searching through the list of the map points assigned to the determined voxel for the map point nearest to the point of the point cloud and evaluating the candidate position based on the distance of the point of the point cloud to the map point of the list nearest to the point of the point cloud.

According to one embodiment, the method includes performing localization of the robot device using Monte-Carlo Localization, wherein each candidate configuration corresponds to a particle and the method includes weighing each particle according to the evaluation of the candidate position.

According to one embodiment, the method includes determining the distance of the point of the point cloud to the map point of the list nearest to the point of the point cloud for each point of the point cloud and evaluating the candidate position based on a combination of the determined distances.

According to one embodiment, each candidate configuration includes a candidate position.

According to one embodiment, each candidate configuration includes a candidate orientation.

According to one embodiment, the environment is a 3D environment and the map is a 3D map.

According to one embodiment, the observation is acquired from sensor data obtained by a sensor of the robot device.

According to one embodiment, the sensor data includes lidar sensor data and/or radar sensor data.

According to one embodiment, the method includes determining a configuration of the robot device from the evaluated candidate positions.

According to one embodiment, a method for controlling a robot device is provided including performing localization of the robot device of any one of the embodiments described above and controlling the robot device according to the determined configuration.

According to one embodiment, a robot control system is provided including one or more sensors, a memory and a processing unit configured to perform the method of any one of the embodiments described above.

According to one embodiment, a computer program element is provided including program instructions, which, when executed by one or more processors, cause the one or more processors to perform the method of any one of the embodiments described above.

According to one embodiment, a computer-readable medium is provided including program instructions, which, when executed by one or more processors, cause the one or more processors to perform the method of any one of the embodiments described above.

### BRIEF DESCRIPTION OF THE DRAWINGS

The invention will be better understood with reference to the detailed description when considered in conjunction with the non-limiting examples and the accompanying drawings, in which:

FIG. 1 shows a robot.

FIG. 2 illustrates the representation of a robot's position as a probability distribution.

FIG. 3 illustrates an iterative process for Monte-Carlo localization.

FIG. 4 illustrates the generation of a sparse map hash table.

FIG. 5 shows a flow diagram illustrating a method for performing localization of a robot device.

FIG. 6 shows a robot control system according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a” “an” and “the” as used with regard to a feature or element include a reference to one or more of the features or elements.

As used herein, the term “and/or” includes any and all combinations of one or more of the associated listed items.

In the following, embodiments will be described in detail.

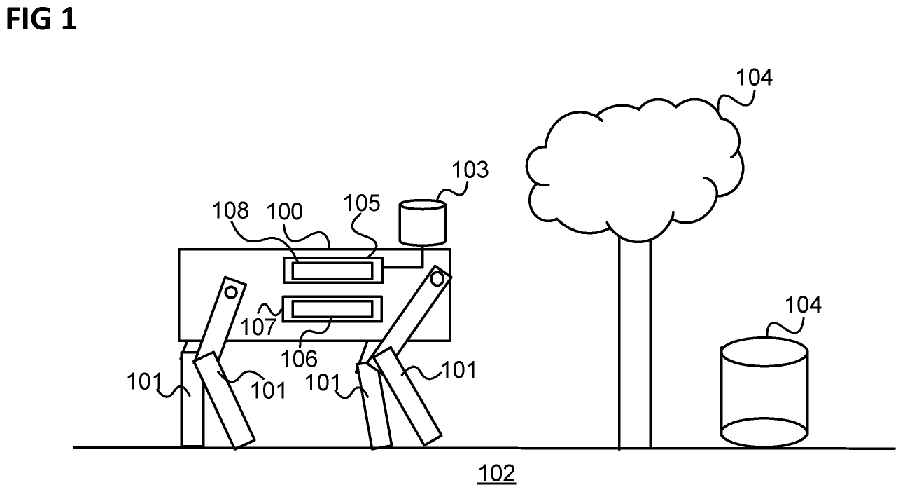

FIG. 1 shows a robot 100.

The robot 100 is a mobile device. In the example of FIG. 1, it is a quadruped robot having four legs 101 for walking on ground 102 and having a lidar sensor 103 (or multiple lidar sensors) to observe its environment (i.e. its surroundings), in particular the ground 102 and objects 104 (typically obstacles). Alternatively or in addition to lidar, the robot may also acquire other types of sensor data, e.g. radar data, images (e.g. RGB-D, i.e. colour plus depth, images) of the robot's environment.

Via the acquired sensor data, the robot 100 observes surface points of objects in the robot's environment. These surface points may be represented as a point cloud, i.e. a processing device 105 of the robot may generate a point cloud 108 from the sensor data delivered by the one or more sensors 103 which includes points for 3D locations indicating surface points of the objects 104 found by the one or more sensors 103.

The robot 100 may further store a 3D map 106 of its environments in a memory 107. The 3D map may also be represented in form of a point cloud, i.e. an array of points wherein each point defines the spatial position of an object (i.e. landmark) surface point in 3D space expressed in terms of (x,y,z) coordinates. So, these points represent objects observed by a lidar (or possibly other sensors) when building the map.

Using the point cloud 108 generated from the sensor data (which the robot 100 has received at its current position) and the map 106, the data processing device 105 may perform localization, i.e. determine the robot's position and/or orientation within the environment by matching the point cloud 108 with the map 106.

Mobile robot localization may be performed using probabilistic methods. One approach is the usage of a particle filter. Such approaches are typically referred to as Monte-Carlo Localization.

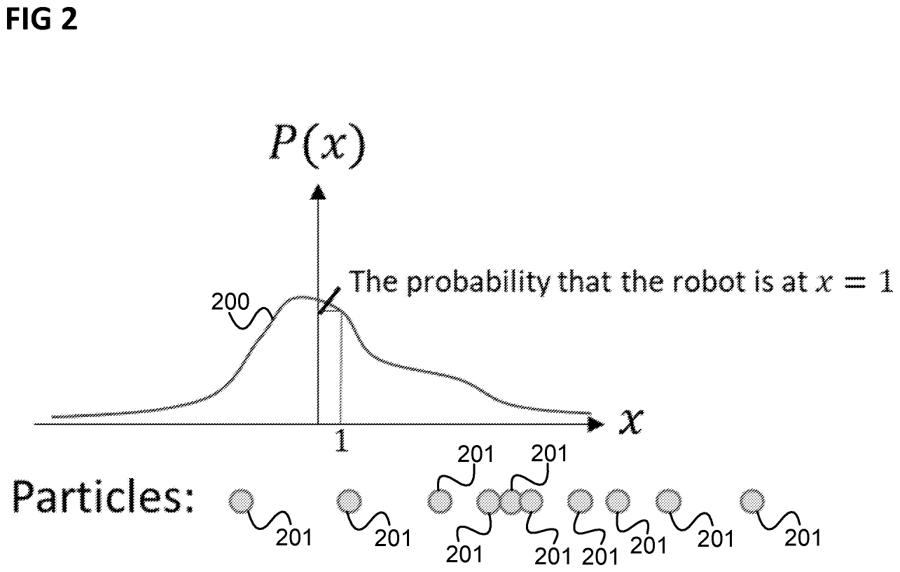

FIG. 2 illustrates the representation of a robot's position as a probability distribution 200 (also known as the belief of the robot).

The complete pose of the robot in 3D space may be represented by six values (e.g. a tuple (x, y, z, θ, φ, ω)), so the actual probability distribution of the pose is in 6D space (rather than in 1D space as illustrated in FIG. 2) and gives, for each 6D point, the probability that the robot 100 has the pose given by the 6D point. It should be noted that if in the following the position of the robot 100 is mentioned this may in general be the robot's pose (i.e. include orientation). This means that each particle may not only represents a position but also the complete pose. The term “configuration” may also be used to refer to position, orientation or pose.

According to various embodiments, a particle filter based approach for localization is used (e.g. by the processing device 105). This means that instead of solving mathematical equations with the probability distribution 200, the probability distribution 200 is sampled, i.e. is represented by a plurality of samples. Each sample is called a particle 201.

For localization at a time t (i.e. a current time), it is assumed that the probability distribution 200 of the robot 100 at the previous time (or time step) t−1 is known. The objective of the localization is to determine the probability distribution at the current time-step t. Further, it is assumed that the robot has a means to estimate its movement (or generally its pose change) from t−1 to t, e.g. by performing odometry based on sensor readings of a motion sensor of the robot 100.

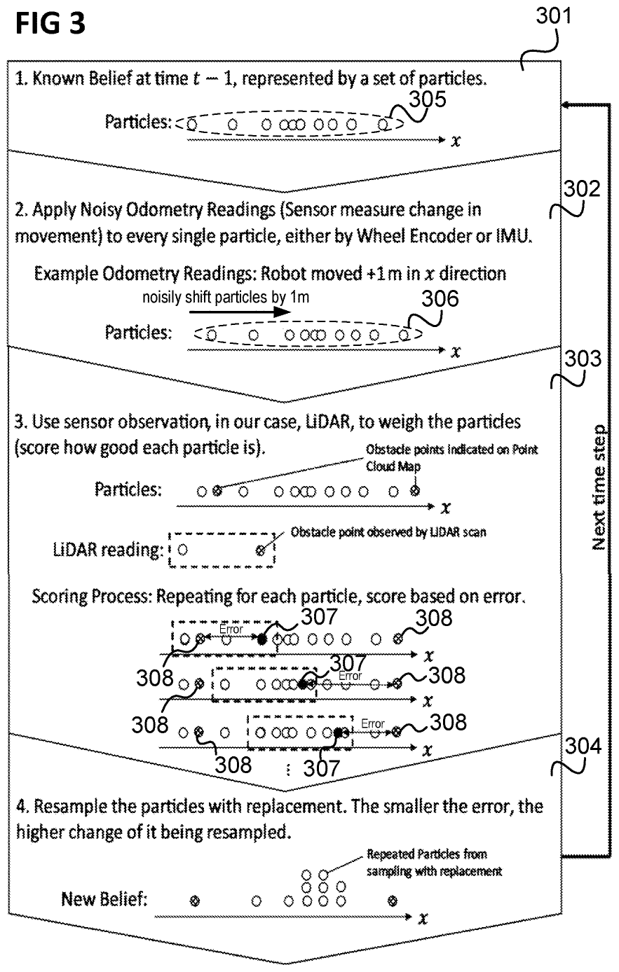

FIG. 3 illustrates an iterative process for Monte-Carlo localization.

The process starts, in 301, with the known probability distribution for time t−1 which is represented by a set of particles 305.

In 302, the movement estimate (obtained from odometry) of the robot from time t to time t−1 is applied to each particle such that there is a set of updated particles 306 which includes an updated particle for each particle of the set 305. The updated particle for a particle represents the position which corresponds to the position represented by the (unupdated) particle which is adjusted by the estimated movement (e.g. shifted; for a pose this may also include turning). This may be done including noise, e.g. when a movement of 1 m to the right has been estimated, each particle is randomly shifted to the right according to a probability distribution with average 1 m.

In 303, for each particle in the set of updated particles 306 a score is calculated using the sensor data (observation). This is done as follows: the particle represents an estimate of a position. According to the map and this estimated position, obstacles 104 are expected at certain positions relative to the robot (i.e. at certain distances and directions). These expected positions are matched with the points of the point cloud obtained from the sensor data. Thus, an error may be calculated using the distance of each point in the point cloud to the nearest map point (i.e. the nearest point for which the map specifies that there is actually an obstacle). The error for a point in the point cloud is discarded if the distance between that point and the nearest map point is over a threshold. The error of the particle (which may be seen as candidate position or candidate position estimate) is then a combination of all these minimum distances, e.g. the summation of them or their average according to some averaging function, etc.

The score of the particle is determined based on the error (e.g. as the inverse of the error).

In 304, particles for the current position (i.e. for time t) are re-determined where the probability that a particle is re-sampled (i.e. is kept in the set of particles) is the higher the smaller the error (i.e. the higher the score). Particles that are not selected are simply removed. The same particle can be selected multiple times to form multiple copies of it in the new set of particles (such that the number of particles may stay the same even if some are removed).

For the above localization approach, as explained, in 303, the error of each particle is computed by projecting the point cloud generated from the scan data for time t (e.g. lidar scan) onto each particle and then performing a nearest neighbour search for each point of the point cloud with respect to the map 106. This means that the positions of obstacle surface points in the map reference frame are calculated by assuming that the robot 100 is at the position (or generally has the pose) represented by the particle and calculating obstacle surface positions (also referred to as observed points or projected points) from their positions relative to the robot as given by the scan data) and then using the displacement (distance) of the observed points from their respective nearest map points (i.e. points of obstacle surface positions given by the map). This process is also known as Scan-To-Map matching. Because the nearest map point (i.e. obstacle surface point included in the map) is used for the error of the particle, in a straightforward approach, the data processing device 105 needs to go, for each projected point, over all possible obstacle surface points in the map and find the nearest point to the projected point. However, the map 106 can potentially be very large such this results in a high computational effort which may be so high that real-time localization is no longer possible.

The example in FIG. 3 only shows 10 particles (one lidar scan point 307 and two obstacle points 308 from the map). This implies that the nearest neighbour search only has to be done 10×1 times. In reality, however, a 16 channel lidar may have approximately 30000 scan points with Monte-Carlo Localization typically using around 500 particles. To improve run-time performance, a practical implementation typically subsamples about 500 scan points for the lidar scan to perform scan-to-map matching. However, doing so still requires 500×500 nearest neighbour queries. This is not scalable as point cloud maps typically have millions of points. This results in the scan-to-map matching process being prohibitively slow for the localization algorithm. In order for such a localization to be deployed realistically on robots, real time performance on the order of 10 Hz is required.

Let:

$$Number of sub - sampled lidar scan points used for scan = K$$

$$Number of Particles used for Monte - Carlo Localization = N$$

$$Number of points in the Point Cloud Map = P$$

These parameters specify the problem size of the nearest neighbour search. The computational effort of the straightforward method of searching every point when doing scan matching scales with O(KNP).

Between the three variables, P can potentially scale to extremely large numbers when deployed on real-world point cloud maps. K and N can usually be kept constant at around 500 without any significant deterioration in localization. Hence, it is desirable to have the localization's performance scale with P.

An approach to increase the usage of KD-trees for the search. This includes building a KD-Tree of the P particles in the point cloud map, where each leaf on the tree represents a small subset of points, and searching down the KD-Tree using the query point until the leaf. The nearest neighbour is one of the points within the leaf. Thus, a time complexity of O(log P) and a (memory) space complexity of O(P) can be achieved. However, while this may be usable in certain scenarios, a time complexity of O(log P) may still be too high for large maps running on edge computing devices.

Another approach is the usage of Occupancy Grid Map & Distance Field Look-ups. This includes constructing a grid array of the bounds of the operating environment. For each cell of the grid the distance to the nearest occupied cell is pre-computed. For the nearest-neighbour look-up, the corresponding cell on the grid array is queried to find distance from the nearest map obstacle. This leads to a constant time complexity during runtime but to a space complexity of O(LWH) where L, W and H are the length, width, and height of the environment, respectively. Thus the space complexity does not scale well for 3D Maps and will quickly overwhelm even any workstation PC. So, this approach can only be reasonably applied for 2D localization in limited settings (as the space complexity is O(LW).

In view of the above, according to various embodiments, a sparse map approach for mobile robot localization is provided.

In this context, a sparse map is a representation of the 3D point cloud map 106 for the nearest neighbour search. A O(1) distance field query without paying for the space complexity of O(LWH) as in Occupancy Grid Map & Distance Field Look-up is desirable.

This is achieved by implementing a spatial hash table data structure (i.e. a sparse map hash table). This approach allows utilizing this data structure it as if it was a regular occupancy grid without the constraints of the Occupancy Grid Map & Distance Field Look-up described above.

The inputs to the spatial hash table data structure are the 3D map points, e.g. specified by (x,y,z) coordinates. Each 3D map point is discretized 3D point into an (i,j,k) voxel grid of the environment which is spatially hashed into a bucket index suitable as an entry for a hash table. By choosing an appropriate voxel size for the environment, points nearest to the query point (i.e. the point of the point cloud obtained from the scan data for which a nearest map point should be determined) will likely reside in the same voxel (and thus correspond to the in the same row in the hash table) as its nearest map point (i.e. its nearest neighbour). This reduces the number of possible nearest neighbour checks (i.e. the map points which need to be check whether they are nearest to the query point) quite dramatically. The expected runtime performance is around a number of <10 due to potential hash table collisions.

Table 1 below describes the sparse map approach according to one embodiment in pseudocode.

TABLE 1
Sparse Map Look-up

| | |
|---|---|
| Pre-Processing | Build Sparse Map (i.e. sparse map hash |
| (Before Localization | table) |
| starts) | Input: point_cloud_map |
| | Output: sparse_map //Note: sparse_map is a |
| | spatial hash table. |
| | 1. for point in point_cloud_map: |
| | 2. point_key ←- hash(point.x, point.y, |
| | point.z) |
| | 3. sparse_map.add_entry(point_key, point) |
| | 4. return sparse_map |
| Runtime (During | Nearest Neighbour Sparse Lookup |
| nearest neighbour | Input: query_point, sparse_map |
| lookup) | Output: nearest_neighbour_distance //Note: |
| | This is also the “error”. |
| | 1. query_key ← hash(query_point.x, |
| | query_point.y, query_point.z) |
| | 2. possible_nns ←- |
| | sparse_map.lookup(query_key) |
| | 3. min_dist ← Infinity |
| | 4. for neighbour in possible_nns: |
| | 5. curr_dist ← get_distance(query_point, |
| | neighbour) |
| | 6. if curr_dist < min_dist: |
| | 7. min_dist ← curr_dist |
| | 8. return min_dist |

In the pre-processing, a Sparse Map representation (sparse map hash table) is built from the map.

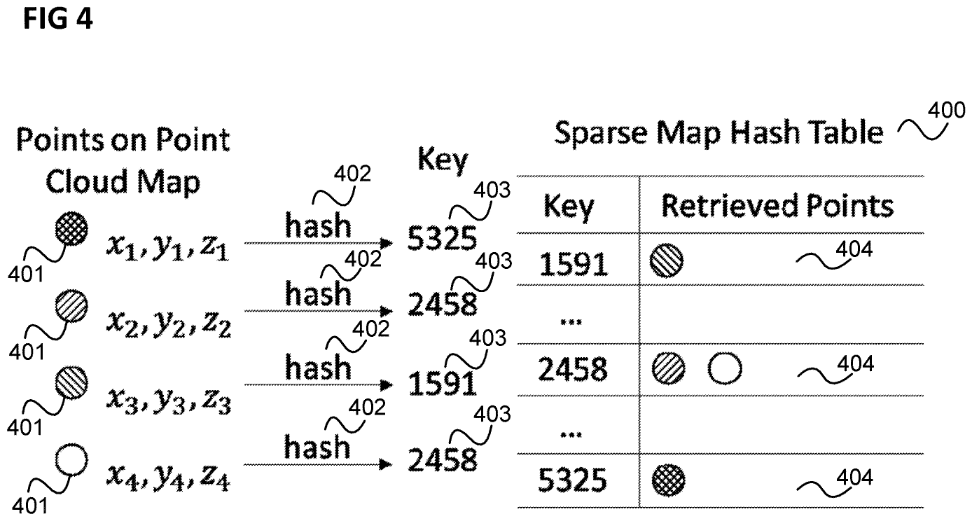

FIG. 4 illustrates the generation of a sparse map hash table 400.

For building the sparse map hash table 400 the hash function 402 is used to map the co-ordinates of each map point 401 (i.e. to hash the coordinates of the map point) to output a hash table key 403 for the map point 401. In the sparse map hash table, there is a list 404 of map points 401 for each hash value (which is used as table key) 403 which are mapped to that hash value.

During runtime, i.e. when performing localization for a time t, for each point of the point cloud obtained from the sensor data of time t (e.g. for each lidar scan point) the coordinates of the points are hashed and the list of map points associated with that hash value (i.e. included in the voxel having that hash value) are looked up in the sparse map hash table. Then, the straightforward nearest neighbour check for all points retrieved from the hash table in this manner for the point is performed (i.e. a linear search through the list of map points associated with the hash value which hashing the coordinates of the point of the point cloud gives).

Hashing the coordinates of a point (which may be a point of the point cloud obtained from the sensor data as well as a map point) means using its (x,y,z) co-ordinate to find out which voxel this point lies in (in the i,j,k coordinate system of the voxels), then hash the voxel co-ordinates (i, j, k) (i.e. basically hashing the voxel).

Thus, all points lying in the same voxel are hashed to the same hash value (and thus table key). The hash function takes in the (i,j,k) co-ordinate of the voxel as inputs to produce the hash key. The (x,y,z) co-ordinate can easily be converted to the (i,j,k) co-ordinate as the map bounds are found at the time of building the map. Thus, the minimum values for the coordinates x_min, y_min, z_min are known for that map. To get (i,j,k) co-ordinates of the voxel that a point (x, y, z) lies in, one can simply take i=floor((x−x_min)/x_resolution), j=floor((y−y_min)/y_resolution), k=floor((z−z_min)/z_resolution). In that case, the physical interpretation of the i,j,k co-ordinate is basically that the voxel is the i-th voxel from the left, j-th voxel from the top and k-th voxel from the front of the entire voxel grid.

Hashing using the (i,j,k) co-ordinates of the voxel is how all voxels have a different input. (Two different voxels can still be mapped to the same key due to hash table collisions. This is unavoidable, but a good hash function will minimise this.)

The Nearest Neighbour Sparse Lookup is used for each point of the point cloud obtained from the scan data to determine the error according to 303 of FIG. 3.

With the sparse map approach described above (e.g. in its implementation according to table 1), a time complexity (during runtime) of O(1), i.e. constant with respect to the problem size, and a space complexity of O(P) can be achieved.

Table 2 gives a comparison of the performance of the sparse map approach (also referred to as sparse lookup) and a KD-tree based approach for three maps.

TABLE 2

| | Map 1 | Map 2 | Map 3 |
|---|---|---|---|
| Number of Points in | 1948827 | 1259135 | 229297 |
| Point Cloud Map | | | |

Desktop Performance, average run time per iteration/ms

| | | | |
|---|---|---|---|
| Sparse Lookup | 13.00 | 15.08 | 11.90 |
| KD-Tree | 42.13 | 42.94 | 37.20 |

Lightweight Edge computing device performance,
average run time per iteration/ms

| | | | |
|---|---|---|---|
| Sparse Lookup | 61.98 | 64.51 | 19.88 |
| KD-Tree | 182.59 | 185.19 | 76.10 |

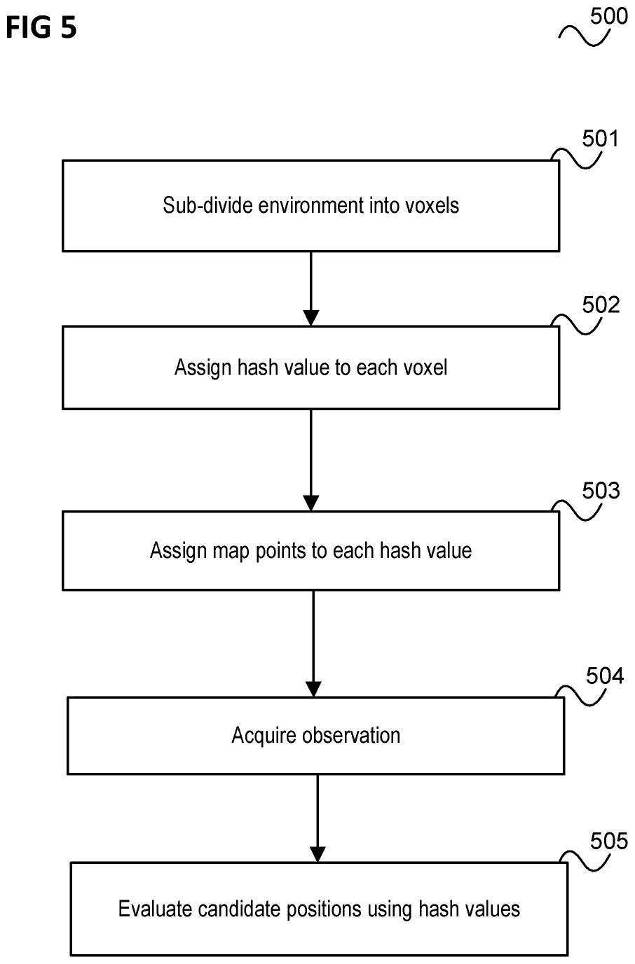

In summary, according to various embodiments, a method is provided as illustrated in FIG. 5.

FIG. 5 shows a flow diagram illustrating a method for performing localization of a robot device.

In 501, an environment of the robot device is sub-divided into a plurality of voxels.

In 502, a hash value is assigned to each voxel.

In 503, to each hash value, a list of map points of a map of the environment of the robot device which are located in the voxel to which the hash value is assigned.

In 504, at every iteration of multiple iterations of localization
an observation is acquired via a point cloud indicating object surface points in the environment relative to the robot device and
for each of a plurality of candidate configurations of the robot device within the environment, for each point of the point cloud, the hash of voxel to which the point would belong if the robot device were at the candidate position is determined, a linear search through the list of the map points assigned to the determined voxel for the map point nearest to the point of the point cloud is performed and the candidate position is evaluated based on the distance of the point of the point cloud to the map point of the list nearest to the point of the point cloud.

According to various embodiments, in other words, a Monte-Carlo localization is carried out wherein the nearest neighbour search for each point is performed within map points which have the same hash value as the point according to hash function.

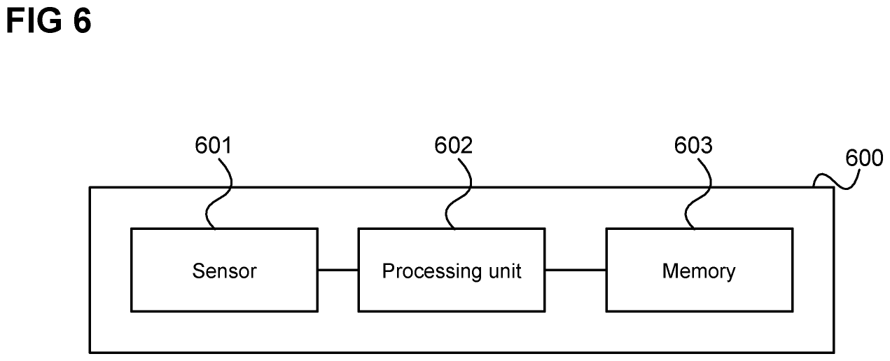

The method of FIG. 5 is for example carried out by a robot control system as illustrated in FIG. 6.

FIG. 6 shows a robot control system 600 according to an embodiment.

The robot control system 600 includes a sensor 601 (attached to a robot, e.g. configured to sensor data such as lidar data). The robot control system 600 further includes a processing unit 602 and a memory 603. The memory 603 may be used to store, for example, the map, the map, the list of map points associated with each hash value (e.g. the sparse map representation and the point cloud according to the (current) observation). It should be noted that the localization may be performed by a remote device, i.e. the processing unit 602 and/or the memory 603 do not necessarily have to be part of the robot. The robot control system 600 is configured to perform the method of FIG. 5. The robot is generally a robot device which may include any mobile device (in particular mobile devices whose movement may be actively controlled) like vehicles etc.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for performing localization of a robot device comprising:
Sub-dividing an environment of the robot device into a plurality of voxels;
Assigning a hash value to each voxel;
Assigning, to each hash value, a list of map points of a map of the environment of the robot device which are located in the voxel to which the hash value is assigned;
At every iteration of multiple iterations of localization
Acquiring an observation via a point cloud indicating object surface points in the environment relative to the robot device; and
Determining, for each of a plurality of candidate configurations of the robot device within the environment, for each point of the point cloud, the hash of voxel to which the point would belong if the robot device were at the candidate position, linearly searching through the list of the map points assigned to the determined voxel for the map point nearest to the point of the point cloud and evaluating the candidate position based on the distance of the point of the point cloud to the map point of the list nearest to the point of the point cloud.

2. The method of claim 1, comprising performing localization of the robot device using Monte-Carlo Localization, wherein each candidate configuration corresponds to a particle and the method comprises weighing each particle according to the evaluation of the candidate position.

3. The method of claim 1, comprising determining the distance of the point of the point cloud to the map point of the list nearest to the point of the point cloud for each point of the point cloud and comprising evaluating the candidate position based on a combination of the determined distances.

4. The method of claim 1, wherein each candidate configuration comprises a candidate position.

5. The method of claim 1, wherein each candidate configuration comprises a candidate orientation.

6. The method of claim 1, wherein the environment is a 3D environment and the map is a 3D map.

7. The method of claim 1, wherein the observation is acquired from sensor data obtained by a sensor of the robot device.

8. The method of claim 1, wherein the sensor data comprises lidar sensor data and/or radar sensor data.

9. The method of claim 1, comprising determining a configuration of the robot device from the evaluated candidate positions.

10. A method for controlling a robot device comprising performing localization of the robot device according to claim 9 and controlling the robot device according to the determined configuration.

11. A robot control system comprising one or more sensors, a memory and a processing unit configured to perform the method of claim 1.

12. A computer program element comprising program instructions, which, when executed by one or more processors, cause the one or more processors to perform the method of claim 1.

13. A computer-readable medium comprising program instructions, which, when executed by one or more processors, cause the one or more processors to perform the method of claim 1.
